(19) United States
(12) Patent Application Publication
(10) Pub. No.: US 2005/0186008 A1
(43) Pub. Date: Aug. 25, 2005

(54) Printer with cutter and method for cutting recording paper

(75) Inventor: Ryo Imai, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/060,545

(22) Filed: Feb. 18, 2005

(30) Foreign Application Priority Data
Feb. 19, 2004 (JP) 2004-043415

(51) Int. Cl. B41J 15/16; B41J 15/04; B41J 11/66; B41J 11/70

(52) U.S. Cl. 400/618; 400/621; 400/619

(57) ABSTRACT

A front tension roller transports a recording paper applying a predetermined tension to the recording paper recorded by a thermal head. The recording paper having passed the front tension is transported to a cutter by a paper discharge roller. When the paper discharge roller stops rotating for the cutter to cut the recording paper, a curl of the recording paper is generated decreasing the front tension, between the front tension roller and the paper discharge roller. The torque of the tension roller is increased while the paper discharge roller stops rotating. A dancer roller disposed between the tension roller and the paper discharge roller absorbs a part of reactive force caused by the curl.

### BACKGROUND OF THE INVENTION

1. Field of the Invention

The present invention relates to a printer with a cutter and a method for cutting a continuous recording paper into a sheet.

2. Background Arts

Japanese Patent Laid-Open Publication Number 2001-121763, for example, has disclosed a line printer that records images on recording areas of a continuous recording paper one line at a time by means of a print head while transporting the recording paper, and transports the recorded areas to a cutter by means of a paper discharge roller pair disposed at the downstream side of the print head, then cuts each recorded area sequentially. This line printer contains tension rollers at the downstream side of the print head and performs recording applying a front tension to the recording paper.

It is preferable to stop the transportation of the recording paper in a cutting operation, such that a cutting line of the recording paper will not move from its proper position. However, stopping the entire recording paper undesirably prolongs the print time. To solve this problem, the line printer of the prior art stops the recording paper only at the cutting position, while continuing the transportation of the recording paper at the recording position. Thereby, this line printer prevents cutting lines of recorded areas from moving, without stopping recording.

However, even cutting the recording paper with the recording paper stopped, the cutting impact reaches the recording paper in press at the upstream side of the cutter. Since this impact acts in the opposite direction of the transporting direction, the front tension is decreased and that causes narrow lines (lines with higher density) to be printed on the recording paper. In order to prevent the cutting impact from reaching the recording paper at the upper stream of the cutter, the line printer of the prior art absorbs the impact by adding nipping pressure of the paper discharge rollers on the recording paper, or by purposely forming a curl of the recording paper between the paper discharge rollers and the tension rollers when cutting the recording paper.

Although the cutting method of the prior art prevents the narrow lines caused in the cutting operation, it is not capable of preventing wide lines having higher density caused by the stop of the paper discharge rollers.

### SUMMARY OF THE INVENTION

An object of the present invention is to provide a printer with a cutter and a method for cutting a recording paper that are capable of preventing wide lines having higher density from being recorded on the recording paper by stopping the recording paper to cut the same.

The above object is achieved by countervailing the decrease of the front tension caused by a curl formed on the continuous recording paper between tension rollers and paper discharge rollers.

The tension rollers are disposed at the downstream side of the print head and transport the recording paper applying a predetermined tension to the part of the recording paper having been recorded by a print head. The paper discharge rollers are disposed between the tension rollers and the cutter and transport the recording paper to the cutter. The paper discharge rollers stop rotating when a cutting line on the recording paper reaches the cutter. Owing to the stop of the paper discharge rollers, a curl of the recording paper is formed between the tension rollers and the paper discharge rollers. The curl generates a reactive force that pushes the recording paper back to the tension rollers by the elasticity of the recording paper and decreases the front tension.

A preferable embodiment of the present invention equalizes the front tension to the recording paper when the paper discharge rollers stops rotating with it when the paper discharge rollers rotates, by increasing torque of the tension rollers when the paper discharge rollers stops rotating. Another preferable embodiment of the present invention provides a reactive force absorbing device between the tension rollers and the paper discharge rollers. The reactive force absorbing device absorbs the reactive force caused by the curl that acts on the recording paper to decrease the front tension. The reactive force absorbing device includes a dancer roller biased by a spring. It is desirable to increase the torque of the tension roller in combination with using the reactive force absorbing device.

According to the present invention, the decrease of the front tension caused by the curl is countervailed, since the torque of the tension rollers is increased and/or the recording paper is pushed in the direction enlarging the curl at least while the paper discharge rollers stop rotating. Thereby, the front tension is maintained at approximately the same level, regardless of the rotation or the stop of the paper discharge rollers. Thus, it prevents wide lines as uneven density from being printed on the recording paper.

### BRIEF DESCRIPTION OF THE DRAWINGS

One with ordinary skill in the art would easily understand the above-described objects and advantages of the present invention when the following detailed description is read with reference to the drawings attached hereto.

FIG. 1 is a block diagram illustrating an outline of a color thermal printer;

FIG. 2 is a block diagram illustrating a reactive force absorbing device; and

FIG. 3a-3C are explanatory views illustrating operations during a cutting operation.

### PREFERRED EMBODIMENTS OF THE INVENTION

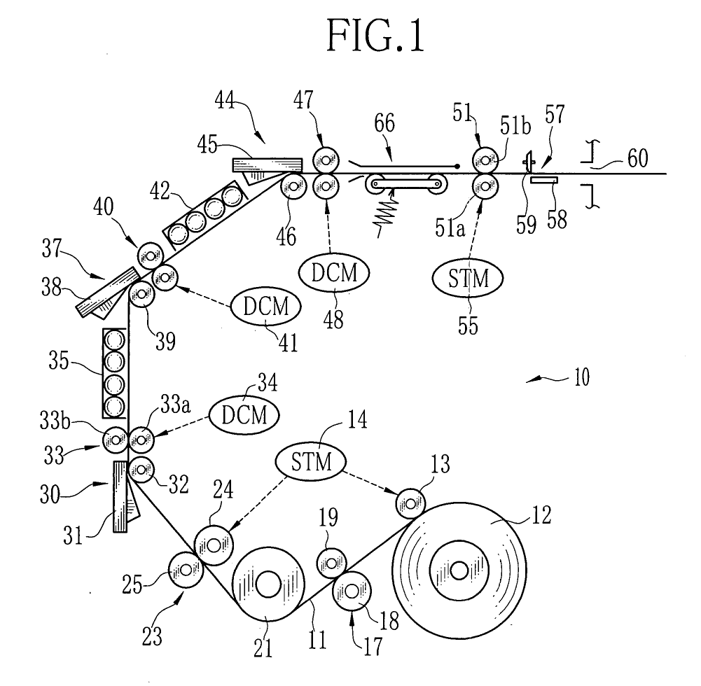

As shown in FIG. 1, a recording paper roll 12, in which a continuous color thermal recording paper (hereinafter referred to as a recording paper) 11 is wound into a roll, is loaded in a color thermal printer (hereinafter referred to as a printer) 10. A paper feed roller 13 is contact with the periphery of the recording paper roll 12 and rotates it to feed the recording paper 11 into a transportation path stretching from a paper feeding part to an eject opening. After print operation, the paper feed roller 13 reverses to rewind the recording paper to the recording paper roll 12. The paper feed roller 13 is rotated by a stepping motor (STM) 14.

In the recording paper 11, a cyan thermal coloring layer, a magenta thermal coloring layer, and a yellow thermal coloring layer are laid on a support in the stated order, as commonly known. The yellow thermal coloring layer, laid on top of the other two coloring layers, is the most thermosensitive among the three thermal coloring layers and develops yellow color with low thermal energy. The cyan thermal coloring layer, lying under the other two thermal coloring layers, is the least thermosensitive among the three thermal coloring layers and needs high thermal energy to develop cyan color. The yellow thermal coloring layer loses its ability to color when exposed by near ultraviolet rays of 420 nm. The magenta thermal coloring layer develops magenta color by thermal energy between the ones to develop yellow color and cyan color, and loses its ability to develop color when exposed by near ultraviolet rays of 365 nm. Note that it is also possible to form four-layered recording paper by providing the recording paper 11 with a black thermal coloring layer.

The recording paper 11 drawn out from the recording paper roll 12 is transported passing between a capstan roller 18 and a pinch roller 19 of a back tension roller pair 17. When a sensor (not shown) disposed at the downstream side of the back tension roller pair 17 detects the front end of the recording paper 11, a shift mechanism (not shown) operates to press the pinch roller 19 against the capstan roller 18 to nip the recording paper 11.

The capstan roller 18 is rotated by a DC motor (not shown) and transports the recording paper to an aligning roller 21 disposed at the downstream side. The aligning roller 21 corrects misalignment of the recording paper 11.

At the downstream side of the aligning roller 21, a transport roller pair 23 is disposed for controlling a transportation speed for the recording paper 11. When the front end of the recording paper 11 is detected by a sensor (not shown) disposed at the downstream side of the transport roller pair 23 after passing between a capstan roller 24 and a pinch roller 25 of a transport roller pair 23, a shift mechanism (not shown) operates to press the pinch roller 25 against the capstan roller 24. The capstan roller 24 is rotated by the stepping motor 14 to transport the recording paper 11 in the downstream direction.

A yellow print station 30 is disposed at the downstream side of the transport roller pair 23. The yellow print station 20 comprises a yellow printing thermal head 31 for printing a yellow image on the yellow thermosensitive recording layer pressing against the recording paper 11, a platen roller 32 for nipping the recording paper 11 with the yellow printing thermal head 31, and a front tension roller pair 33 for nipping and transporting the recording paper 11.

The recording paper 11 transported by the transport roller pair 23 passes between the thermal head 31 and the platen roller 32, then between a capstan roller 33a and a pinch roller 33b of the front tension roller pair 33. When the front end of the recording paper 11 is detected by a sensor (not shown) disposed at the downstream side of the front tension roller pair 33, a shift mechanism (not shown) operates to press the pinch roller 33b against the capstan roller 33a. Simultaneously, the thermal head 31 presses itself against the recording paper 11.

The front tension roller pair 33 applies the tension (front tension) acting in the transporting direction to the recording paper 11 at the recording position of the thermal head 31. The capstan roller 33a is driven by a DC motor 34. Since the rotational speed of the front tension roller pair 33 is set faster than that of the transport roller pair 23, the difference in the rotational speed between them applies the front tension to the recording paper 11. The back tension evenly counteracting the front tension is applied to the recording paper 11 by the back tension roller pair 17. Thereby, the transportation speed for the recording paper 11 at the recording position of the thermal head 31 is maintained at the transportation speed of the transport roller pair 23, since the transportation amount of the recording paper 11 is controlled by the transport roller pair 23.

When the front edge of the headmost recording area on the recording paper 11 reaches the thermal head 31, the thermal head 31 is activated and prints a yellow image line by line on the yellow thermal coloring layer of the recording paper 11.

A yellow color fixing lamp 35 is disposed at the downstream side of the front tension roller pair 33. The yellow color fixing lamp 35 fixes yellow thermal coloring layer of the recording paper 11 not to develop color by heat, by emitting near-ultraviolet ray having an emission peak at 420 nm and exposing the yellow thermal coloring layer to it.

After the yellow thermal coloring layer is fixed by the yellow color fixing lamp 35, the recording paper 11 is transported to a magenta print station 37. Similarly to the yellow print station 30, the magenta print station 37 comprises a magenta printing thermal head 38 for printing a magenta image on the magenta thermosensitive recording layer pressing against the recording paper 11, a platen roller 39 for nipping the recording paper 11 with the magenta printing thermal head 38, and a front tension roller pair 40 for nipping and transporting the recording paper 11. The front tension roller pair 40 is driven by a DC motor 41.

The recording paper 11, having the magenta image printed by the magenta print station 37, is exposed to ultraviolet ray having an emission peak at 365 nm by the magenta color fixing lamp 42, and thereby the magenta thermal coloring layer is fixed.

After the magenta thermal coloring layer is fixed by the magenta color fixing lamp 42, the recording paper 11 is transported to a cyan print station 44. Similarly to the yellow print station 30 and the magenta print station 37, the cyan print station 44 comprises a cyan printing thermal head 45 for cyan color printing, a platen roller 46, and a front tension roller pair 47. The front tension roller pair 47 is driven by a DC motor 48. A cyan image is printed on the cyan thermosensitive coloring layer of the recording paper 11 by the cyan print station 44. A full-color image is formed by overlaying the yellow image, the magenta image and the cyan image in the same recording area.

The front tension at the downstream side of the transport roller pair 23 is increased every time each front tension roller pair 33, 40 and 47 in each print station operates. However, the transportation speed of the transport roller pair 23 is maintained constantly, since the back tension generated by the back tension roller pair 17 is increased according to the operation of each front tension roller pair 33, 40 and 47.

Each thermal head 31, 38 and 45 sequentially records the image of each color in the recording areas of the recording paper 11. Thereby, a plurality of recording areas are sequentially recorded and a plurality of frames are formed on the recording paper 11. While the recording, a blank of the same length as the distance from each front tension roller pair to each thermal head is formed in front of each recording area. The blank is cut away by a cutter 57, which is described later.

At the downstream side of the cyan print station 44, a paper discharge roller pair 51 is disposed for transporting the recorded areas carrying the full-color images to the cutter 57. The paper discharge roller pair 51 comprises a capstan roller 51a and a pinch roller 51b. The capstan roller 51a is driven by a stepping motor 55.

The cutter 57 is disposed at the downstream side of the paper discharge roller pair 51 for cutting the recording paper 11 on the edge of each recording area. The cutter 57 comprises a plate-like fixed blade 58 disposed orthogonally to the transporting direction of the recording paper 11, and a rotatable cutter that slides on the fixed blade 58 and moves with rotating in the orthogonal direction to the transporting direction of the recording paper 11. The rotatable blade 59 is moved by a cutter moving mechanism (not shown) comprising a belt and a pulley.

The front edge of the recorded area is transported to the cutting position of the cutter 57, and then the blank at the front end of the recording paper 11 is cut away. Subsequently, the rear edge of the recorded area is transported to the cutting position of the cutter 57 and cut by it, such that the recorded area is cut into a sheet of paper. This cutting operation is performed for each recorded area.

In the cutting operation, the paper discharge roller pair 51 is stopped to stop transporting the recording paper 11 at the cutting position, in order to prevent misalignment of the cutting line. On the other hand, the recording paper 11 is transported by the transport roller pair 23 even in the cutting operation, and recording is performed by the print stations 30, 37 and 44. Thus, it shortens the print time successfully.

However, the operation of stopping and resuming the transportation of a part of the recording paper 11 changes the tension applied to the recording paper 11 at the recording position, which results in generating lines with high density on the recording paper described as follows.

First, because of the rigidity of the recording paper 11, the reactive force (resistant force) that inhibits the transportation of the recording paper 11 by the front tension roller pair 47 is generated when the paper discharge roller pair 51 is stopped rotating. The reactive force operates instantaneously with the stop of the paper discharge roller pair 51, and generates comparatively sharp and narrow lines on the image.

Secondly, the recording paper 11 curls between the front tension roller pair 47 and the paper discharge roller pair 51 when the transportation by the paper discharge roller pair 51 is stopped. Since the recording paper 11 is comparatively thick, its elasticity generates a force of restitution. The force of restitution operates as the reactive force and acts in the opposite direction to the front tension. The force of restitution is generated throughout the time the recording paper 11 curls, wide lines are generated on the image. These reactive forces act to decrease the transportation speed, which results in increasing the density in the printing area and producing wide lines on the image.

To deal with this problem, a reactive force absorbing device 66 is disposed between the front tension roller pair 47 and the paper discharge roller pair 51, for preventing the lines of above two types by preventing change of the tension to the recording paper 11.

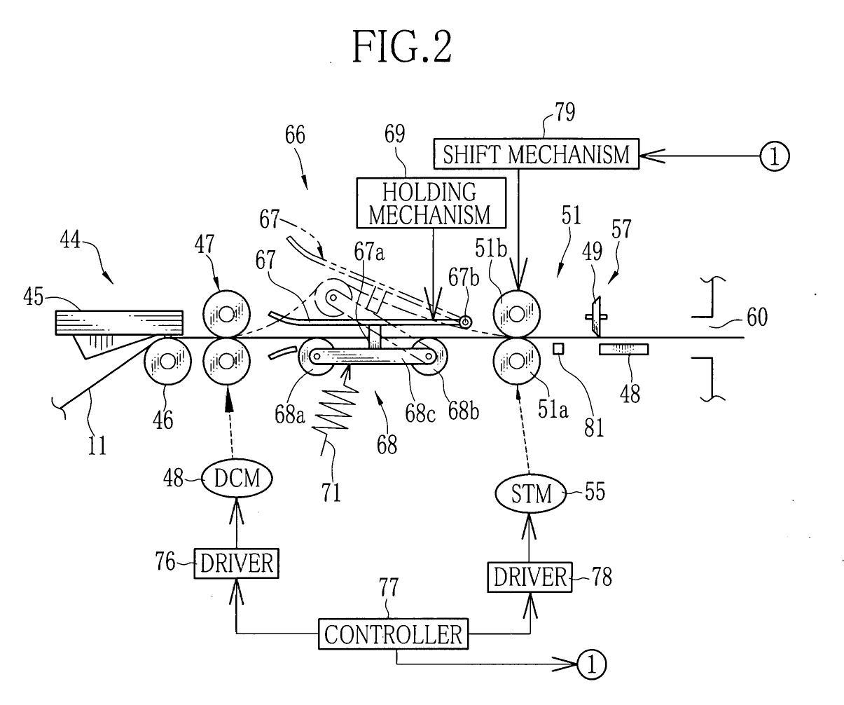

As shown in FIG. 2, the reactive force absorbing device 66 comprises a guide plate 67, a dancer roller unit 68, a holding mechanism 69, and a spring 71. The dancer roller unit 68 comprises a dancer roller 68a and a guide roller 68b connected to each other by an arm 68c, which is provided to swing about a rotational axis of the guide roller 68b. The spring 71 biases the arm 68c, such that the dancer roller 68a swings clockwise about the guide roller 68b, as shown by a chain double-dashed line in the figure. By the bias, the dancer roller 68a pushes the recording paper 11 from its rear face. When the curl of the recording paper 11 is generated as the paper discharge roller pair 51 stops, the dancer roller 68a swings following the curl.

The guide plate 67 is disposed to the opposite side of the dancer roller unit 68 and guides the recording paper 11 being transported between the front tension roller pair 47 and the paper discharge roller pair 51. The guide plate 67 is provided to be swingable about an axis 67b and kicked up to swing clockwise leaving a space for the dancer roller 68a to swing.

The dancer roller unit 68 is held in a predetermined position, shown by a solid line in the figure, leaving a space for the recording paper 11 to pass by means of the holding mechanism 69 when the front end of the recording paper 11 is transported from the front tension roller pair 47. The holding mechanism 69 holds the dancer roller unit 68 in the predetermined position resisting against the bias of the spring 71.

For example, a solenoid, in which a plunger (movable core) is extruded by a current flow in a magnet coil, is applied to the holding mechanism 69. One end of the plunger is fixed to the guide plate 67, such that the guide plate 67 swings following the move of the plunger. The guide plate 67 is provided with a contact member 67a to be contact with the arm 68c of the dancer roller unit 68, and the dancer roller unit 68 is pushed by the contact member 67a by the bias of the spring 71. When the guide plate 67 is kicked up to swing clockwise as released from the holding mechanism 69, the dancer roller 68a swings clockwise following the guide plate 67. When the recording paper 11 is rewound to the recording paper roll 12 after the print operation, the holding mechanism 69 operates to swing the guide plate 67 counterclockwise. In this operation, the dancer roller unit 68 is pushed by the contact member 67a to the predetermined position.

During the cutting operation (the period from the stop of the paper discharge roller pair 51 to the extinction of the curl), the dancer rollers 68a pushes the recording paper 11 and simultaneously the torque of the front tension roller pair 47 is increased. Thereby, the reactive force acting against the front tension is absorbed and the front tension during the printing and the cutting operations is maintained constantly, which prevents generation of the above-stated narrow lines and wide lines without fail.

The DC motor 48 is controlled by a controller 77 via a driver 76. The controller 77 is a microcomputer comprising CPU and a memory, and controls each part of the printer 10. Immediately before stopping the paper discharge roller pair 51, the controller 77 increases the torque of the front tension roller pair 47 by increasing the driving voltage of the DC motor 48, and returns the driving voltage to the original one after the cutting operation.

The pinch roller 51b of the paper discharge roller pair 51 is shifted by a shift mechanism 79 between a pressing position for pressing the recording paper 11, and a retreating position retreated from the pressing position. The shift mechanism 79 is controlled by the controller 77. When the front end of the recording paper 11 is detected by a photo sensor 81, the controller 77 operates the shift mechanism 79 to shift the pinch roller 51b to the pressing position.

The controller 77 also controls the stepping motor 55 for driving the paper discharge roller pair 51, via a driver 78. The timing to stop the paper discharge roller pair 51 is determined by the controller 77 by measuring the transportation amount of the recording paper 11 with counting the number of driving pulses to send to the stepping motor 55 after the front end of the recording paper 11 is detected by a photo sensor 81. That is, the controller 77 starts counting the number of the driving pulses when the front end of the recording paper 11 is detected, and stops the rotation of the paper discharge roller pair 51 when the cutting position of the recording paper 11 reaches the cutter 57.

Since the rotational speed of the paper discharge roller pair 51 is set faster than that of the front tension roller pair 47, the curl of the recording paper 11 is gradually straightened as the paper discharge roller pair 11 resumes transporting the recording paper 11 after the cutting operation by the cutter 57.

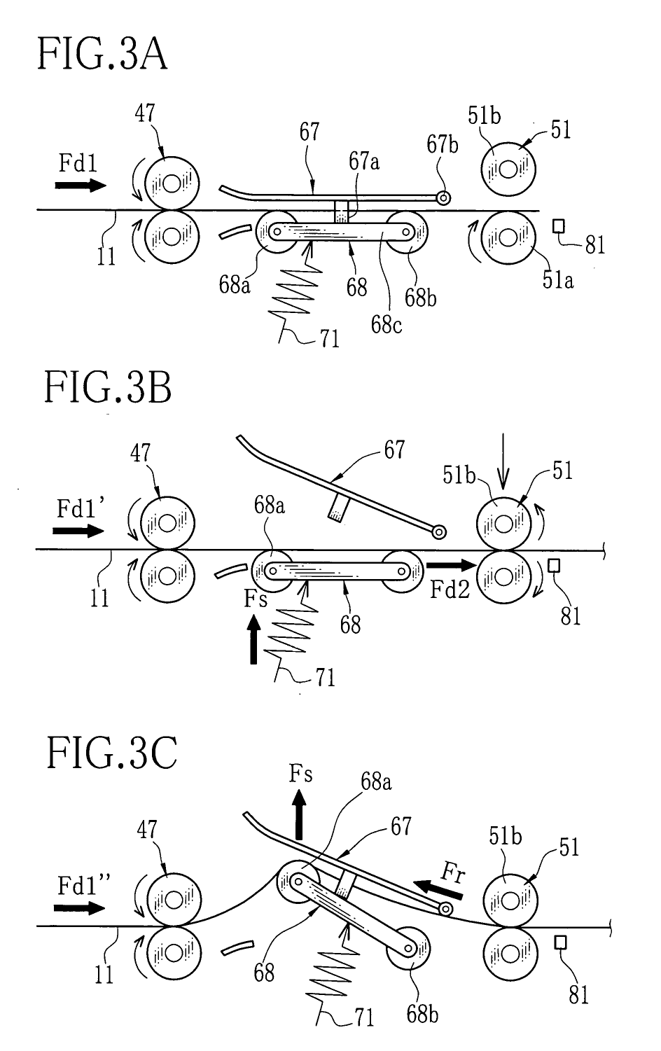

FIGS. 3A, 3B, and 3C together explain the movements of the reactive force absorbing device 66 and the front tension roller pair 47 during the cutting operation. The function of the above constitution is explained as follows, referring to those figures.

The recording paper 11 is transported at the predetermined speed by the transport roller pair 23, while the image is thermally recorded by each print station 30, 37 and 44 and optically fixed by each fixing lamp 35 and 42. At each print station 30, 37 and 44, the recording paper 11 is thermally recorded with being applied the predetermined front tension by each front tension roller pair 33, 40, and 47.

After the cyan image is recorded, the front end of the recording paper 11 is transported to the paper discharge roller pair 51 as guided by the guiding plate 67, as shown in FIG. 3A. In this operation, the dancer roller unit 68 is held in the predetermined position, in which the arm 68c is maintained horizontally, by the holding mechanism 69 in order to restrain the dancer roller 68a from pushing the recording paper 11. When the front end of the recording paper 11 is detected by the photo sensor 81 after passing the paper discharge roller pair 51, the pinch roller 51b shifts to the pressing position, as shown in FIG. 3B. Since the capstan roller 51a is rotating, driving force Fd2 of the paper discharge roller pair 51 is applied to the recording paper 11 when the paper discharge roller pair 51 nips the recording paper 11.

At this point, the guide plate 67 is kicked up to swing clockwise by the holding mechanism 69. Thereby, the dancer roller 68, which has been pressed by the contact member 67a of the guide plate 67, is released to swing and pushes the recording paper 11 on the rear face with the bias of the spring 71.

Simultaneously, the controller 77 increases the torque of the front tension roller pair 47 by increasing the driving voltage of the DC motor 48. Thus, the front tension Fd1 of the front tension roller pair 47 is increased to Fd1′. The increased torque of the front tension roller pair 47 is maintained until the curl of the recording paper 11, caused by the stop of the paper discharge roller pair 51, is straightened after cutting operation and the resumption of rotation of the paper discharge roller pair 51.

When the cutting position of the recording paper 11 reaches the cutter 57, the paper discharge roller pair 51 is operated to stop rotating and the recording paper 11 at the cutter 57 stops as well, as shown in FIG. 3C. Although the front tension is decreased by the resistant force caused by the rigidity of the recording paper 11 at the moment the paper discharge roller pair 51 stops rotating, it is prevented to generate the narrow lines on the recording paper 11 caused by the stop of the paper discharge roller pair 51, since the torque of the front tension roller pair 47 is increased immediately before the paper discharge roller pair stops rotating and the dancer roller 68 biases the recording paper to curl.

Since the recording paper 11 is continuously transported by the front tension roller pair 47 even after the paper discharge roller pair 51 stops rotating, the recording paper 11 curls. The dancer roller 68a swings following the curl of the recording paper 11 and keeps pushing the recording paper 11. When the recording paper 11 curls, the reactive force Fr is generated by the recovery force of the recording paper 11. Since the reactive force Fr obstacles the transportation of the recording paper 11, it acts to decrease the tension by the tension roller pair 47. However, the decrease of the tension caused by the reactive force Fr is prevented, since the torque of the front tension roller pair 47 is increased and a pushing force Fs by the dancer roller 68a is generated. In this state, the tension by the tension roller pair 47 is Fd1″. Because the tensions Fd1′ and Fd1″ are approximately equivalent to the tension Fd1, the change of tension caused by the stop of the discharge roller pair is prevented. Thereby, wide lines caused by the counter force Fr are prevented from generating.

In spite of a force applied to the recording paper 11 by the rotatable blade 59 when the cutter 57 operates, no line caused by this force is generated on the recording paper 11, as the force is blocked by the paper discharge roller pair 51 and the curl of the recording paper 11.

After the cutting operation, the paper discharge roller pair 51 resumes rotating and transports the recording paper 11. Since the rotational speed of the paper discharge roller pair 51 is set faster than that of the front tension roller pair 47, the curl of the recording paper 11 is straightened gradually. As pushed by the recording paper 11, the dancer roller 68a returns to the predetermined position shown in FIG. 3B. When a sensor (not shown) detects that the dancer roller returns to the predetermined position, the controller 77 decreases the torque of the front tension roller pair 47 to the predetermined level.

When the next cutting position reaches the cutter 57, the paper discharge roller pair 51 is stopped again and the recording paper 11 is cut. As stated above, the controller 77 increases the front tension by increasing the torque of the front tension roller pair 47 immediately before stopping the paper discharge roller pair 51. In addition, the dancer roller 68a forms the curl of the recording paper 11 while the recording paper 11 is stopped.

Although the change of the front tension is prevented by pushing the recording paper by the dancer roller and increasing the torque of the front tension roller pair at the same time in the above embodiment, it is possible to apply either one of them.

However, the change of tension, generated as the paper discharge roller pair 51 resumes rotating after the cutting operation, is prevented by using the dancer roller and increasing the torque of the tension roller pair at the same time.

That is, in order to countervail the reactive force Fr generated by the curl of the recording paper 11 with the dancer roller 68a alone, it is required to increase the pushing force Fs by increasing the bias of the spring 71. However, since the pushing force Fs of the dancer roller 68a acts as the back tension to the paper discharge roller pair 51, increasing the pushing force Fs results in increasing the load of the paper discharge roller pair 51 as well. The increase of the load of the paper discharge roller pair 51 possibly disturbs the appropriate transport of the recording paper 11 by the discharge roller pair 51, leading to a paper jam of the recording paper 11 within the transportation path.

One of the conceivable measures to prevent the paper jam is to increase the driving force Fd2 of the paper discharge roller pair 51. However, if the driving force Fd2 is increased too much, it causes an excessive drawing force of the paper discharge roller pair 51 to the recording paper 11. Since this drawing force increases the front tension, it reduces concentration of the colors of the image.

In view of this reduction in the concentration, the pushing force Fs of the dancer roller 68c is, for example, held to about a half of the driving force Fd2 of the paper discharge roller pair 51. However, since the pushing force Fs alone does not add enough front tension to counteract evenly to the reactive force Fr, the shortage of the front tension is supplied by increasing the torque of the front tension roller pair 47. Even the torque of the front tension roller pair 47 is increased, it does not put a load on the paper discharge roller pair 51 and it is not necessary to increase the driving force Fd2 of the paper discharge roller pair 51. Thus, the tension is prevented from changing when the paper discharge roller pair 51 resumes rotating.

Although the torque of the front tension roller pair 47 is increased immediately before the stop of the paper discharge roller pair 51 in view of a response retardation of the DC motor 48 in the above embodiment, it is also possible to increase the torque simultaneously with the stop of the paper discharge rollers 51 if the DC motor 48 does not cause the retardation. Furthermore, it is also possible to return the guide plate 67 by means of the holding mechanism 69 to the position shown in FIG. 3A to hold the dancer roller unit 68, after the curl is straightened with the rotation of the discharge roller pair 51. In this case, the guide plate 67 is released by operating the holding mechanism 69 in the foregoing way, simultaneously with the increase of the torque of the front tension roller pair 47.

Although the color thermal printer is used in the above embodiment, the present invention is also applicable to a thermal transfer printer of sublimation type, which records images by transferring the ink on yellow, magenta, and cyan color ink sheets onto the recording paper by heating the ink sheets by means of the thermal head, and a thermal transfer printer of thermal-wax transfer type, as well as a thermal transfer printer having a thermal head for over-coating in addition to the thermal heads of yellow, magenta, and cyan colors.

Note that the present invention is also applicable not only to thermal printers having thermal heads, but also to various types of printer that records images in a plurality of recording areas on a continuous recording paper being transported and cuts the recorded areas while the images are being recorded. Furthermore, the present invention is also applicable to a printer with a single print head that cuts the recorded areas by a cutter while the print head is recording.

Although the present invention has been described with respect to the preferred embodiments, the present invention is not to be limited to the above embodiments but, on the contrary, various modifications will be possible to those skilled in the art without departing from the scope of claims appended hereto.

1. A printer for recording a plurality of frames by at least a single print head sequentially on a continuous recording paper being transported, said recording paper being cut into each frame by a cutter, said printer comprising:
a tension roller disposed at the downstream side of said print head, for transporting said recording paper applying front tension to said recording paper when said print head is recording the frames on said recording paper;
a paper discharge roller disposed between said tension roller and said cutter, for transporting said recording paper having passed said tension roller to said cutter, and for stopping rotating to form a curl of said recording paper between said tension roller and said paper discharge roller when said cutter is cutting said recording paper; and
a torque control device for applying large torque to said tension roller while said paper discharge roller is stopped, said torque control device equalizing said front tension when said discharge roller stops to said front tension when said paper discharge roller rotates.

2. A printer defined in claim 1, wherein said torque control device increases said torque of said tension roller in the period from immediately before or at the moment when said paper discharge roller stops rotating until said curl is straightened when said paper discharge roller resumes rotating.

3. A printer defined in claim 2, said torque control device comprising:
a motor for driving said tension roller; and
a motor controller for controlling said torque of said tension roller by controlling rotational force of said motor.

4. A printer defined in claim 3, wherein a rotational speed of said discharge roller is faster than that of said tension roller.

5. A printer defined in claim 4, further comprising a reactive force absorbing device disposed between said tension roller and said paper discharge roller, said reactive force absorbing device absorbs reactive force acting on said recording paper to decrease said front tension, by forming said curl.

6. A printer defined in claim 5, wherein said reactive force absorbing device comprising:
a dancer roller capable of moving to an orthogonal direction to a transporting direction of said recording paper; and
a spring for biasing said dancer roller, such that said dancer roller pushes said recording paper following said curl.

7. A printer defined in claim 6, wherein said reactive force absorbing device further comprising a guide plate for guiding the front end of said recording paper to said paper discharge roller, said guide plate is disposed to face said dancer roller and swings to a position aloof from said dancer roller after the front end of said recording paper has passed said guide plate.

8. A printer defined in claim 7, wherein said dancer roller is held in a retreated position resisting against the bias of said spring and released by the swing of said guide plate.

9. A printer for recording a plurality of frames by at least a single print head sequentially on a continuous recording paper being transported, said recording paper being cut into each frame by a cutter, said printer comprising:
a tension roller disposed at the downstream side of said print head, for transporting said recording paper applying front tension to said recording paper when said print head is recording the frames on said recording paper;
a paper discharge roller disposed between said tension roller and said cutter, for transporting said recording paper having passed said tension roller to said cutter, and for stopping rotating to form a curl of said recording paper between said tension roller and said paper discharge roller when said cutter is cutting said recording paper; and
a reactive force absorbing device disposed between said tension roller and said paper discharge roller, said reactive force absorbing device absorbs reactive force that acts on said recording paper decreasing said front tension, by forming said curl.

10. A printer defined in claim 9, wherein said reactive force absorbing device comprising:
a dancer roller capable of moving in an orthogonal direction to a transporting direction of said recording paper; and
a spring for biasing said dancer roller, such that said dancer roller pushes said recording paper following said curl.

11. A recording paper cutting method for cutting a continuous recording paper into each frame by a cutter, said recording paper carrying a plurality of frames sequentially recorded by at least a single print head, said recording paper cutting method comprising steps of:
transporting said recording paper having been recorded by said print head and simultaneously applying tension to said recording paper by a tension roller disposed at the downstream side of said print head;
transporting said recording paper to said cutter by means of a paper discharge roller disposed between said tension roller and said cutter;
stopping the rotation of said paper discharge roller when a cutting line of said recording paper reaches said cutter, said recording paper forming a curl between said tension roller and said paper discharge roller;
operating said cutter to cut said recording paper on said cutting line; and
countervailing decrease of said front tension caused by said curl.

12. A recording paper cutting method defined in claim 11, wherein the step to countervail said front tension is performed in the period from immediately before or at the moment when said paper discharge roller stops rotating until said curl is straightened when said paper discharge roller resumes rotating.

13. A recording paper cutting method defined in claim 12, wherein the step to countervail said front tension is to increase torque of said tension roller.

14. A recording paper cutting method defined in claim 12, wherein the step to countervail said front tension is to push said recording paper in the direction enlarging said curl by means of a dancer roller disposed between said tension roller and said paper discharge roller.
